(19) United States
(12) Patent Application Publication
(10) Pub. No.: US 2026/0243399 A1
(43) Pub. Date: Aug. 20, 2026

(54) SIDE-ENTRY MULTIPLE ATTACHMENT SLIDING BRACKET

(71) Applicant: SIGNIFY HOLDING B.V., EINDHOVEN (NL)

(72) Inventors: MUN CHUNG HAW, MONTREAL (CA); ERIKA PAULUS, MONTREAL (CA); EDGAR PEREZ, MONTREAL (CA)

(21) Appl. No.: 19/453,037

(22) Filed: Jan. 20, 2026

Related U.S. Application Data
(60) Provisional application No. 63/746,136, filed on Jan. 16, 2025.

(30) Foreign Application Priority Data
Jan. 30, 2025 (EP) 25155027.3

(51) Int. Cl. F21S 8/04; F21S 8/06; F21V 21/112; F21V 23/00

(52) U.S. Cl. CPC F21S 8/043; F21S 8/063; F21V 21/112; F21V 23/002

(57) ABSTRACT

According to certain embodiments, a system for installing a plurality of LED luminaires are provided by partially supporting the LED luminaire while aligning and securing the connections with easy. The system also allows for thermal expansion and contraction and further improves aesthetic by hiding the power line. A bracket having a pair of support legs extending from one end and a mounting panel extending from at the other end is provided. A pair of T-rails on the housing is configured to slidably engage with the pair of support legs at a predetermined angle and tilted at a substantially horizontal level for a subsequent fastening to secure mounting of the housing onto the bracket.

### FIELD

The disclosure relates to an apparatus and methods for facilitating easy installation of a lighting assembly that preferably uses LED lighting technology.

### DESCRIPTION OF THE RELATED ART

Modern lighting solution requires precise installation of linear LED lighting assemblies as well as improvement in the speed of installation which in turn results in lowering installation costs. However, achieving accurate alignment during installation when the light fixtures are suspended can be challenging because the conventional light assemblies require rigid steams to be screwed to the housing which adds to the complexity of the installation process. Further, when deployed outside, the luminaire is exposed to the wind and weather. As such, the connection between the ceiling and the light fixture must allow for thermal expansion and contraction. Moreover, the cyclic heat induced stress will wear and break the joints over time. Some of the indoor installation also faces the same thermal drawbacks in certain environments.

Accordingly, it is desirable to an apparatus and methods for facilitating installation of linear LED lighting assemblies to improve the easy and hassle-free installation while allow for thermal expansion and contraction.

### SUMMARY

According to certain embodiments, a system and method for installing a light luminaire can provide easy installation by partially supporting a light fixture while aligning and securing the connections. The system also allows for thermal expansion and contraction and can also be used in different mounting application, including pendant, surface application, and wall application. The system further provides improved aesthetic by hiding the power line within the pendant stem which also serves to protect the wire from foreign object damage.

According to certain embodiment, a system for installing a linear LED luminaire continuously includes: a bracket comprising a pair of support legs extending from one end, and a mounting panel extending from at the other end and including at least one opening to receive at least one screw; and a housing including at least one pair of T-rails on a top surface thereof, and an opening between the pair of T-rails to receive wires, wherein the pair of T-rails of the housing is configured to slidably engage with the pair of support legs at a predetermined angle and tilted at a substantially horizontal orientation while the at least one screw is fastened through the at least one opening of the mounting panel to secure mounting of the housing onto the bracket.

According to certain embodiment, a method for installing a plurality of linear LED luminaires includes: affixing a first bracket and a second bracket onto a ceiling or a suspended pendant stem in a linear format; slidably engaging at least one pair of T-rails provided on a top surface of a first housing including a first linear LED luminaire at a predetermined angle onto a pair of support legs provided under the first bracket and the second bracket; tilting the first housing at a substantially horizontal orientation while the at least one pair of T-rails of the first housing and the second housing are engaged with the pair of support legs provided under the first bracket and the second bracket; affixing at least one screw to mounting panels of the first bracket and the second bracket when the first housing is tilted in the substantially horizontal orientation to secure mounting of the first housing onto the first bracket and the second bracket; and affixing a pair of pre-installed screws provided in the first bracket between the at least one pair of T-rails when the first housing is mounted onto the first bracket and the second bracket such that the heads of the pair of pre-installed screws in the first bracket are configured to block a sliding movement of the pair of T-rails of the first housing.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram of a fixture system in accordance with an embodiment of the disclosure;

FIG. 1B is another diagram of a fixture system in accordance with an embodiment of the disclosure;

FIG. 1C is a diagram of a housing in accordance with an embodiment of the disclosure;

FIG. 2A is an installation schematic for pendant application in accordance with an embodiment of the disclosure;

FIG. 2B is an integrated fixture system for pendant application in accordance with an embodiment of the disclosure

FIG. 3A is an installation schematic for surface application in accordance with an embodiment of the disclosure;

FIG. 3B is another installation schematic for surface application in accordance with an embodiment of the disclosure;

FIG. 3C is another installation schematic for surface application in accordance with an embodiment of the disclosure;

FIG. 3D is another installation schematic for surface application in accordance with an embodiment of the disclosure;

FIG. 4A is a cross section of the fixture system using stopper screws accordance with an embodiment of the disclosure;

FIG. 4B is an installation schematic using stopper screws accordance with an embodiment of the disclosure;

FIG. 4C is a cross section of the fixture system using no stopper screws accordance with an embodiment of the disclosure; and

FIGS. 5A and 5B are illustrative schematics for back-to-back connections of fixture systems in accordance with an embodiment of the disclosure.

### DETAILED DESCRIPTION

It should be appreciated that various embodiments of the present disclosure and the terms used therein are not intended to limit the technological features set forth herein to particular embodiments and include various changes, equivalents, or replacements for a corresponding embodiment. With regards to the description of the drawings, similar reference numerals may be used to refer to similar or related elements.

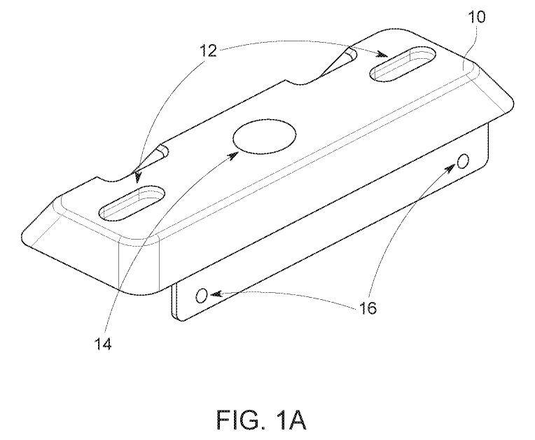

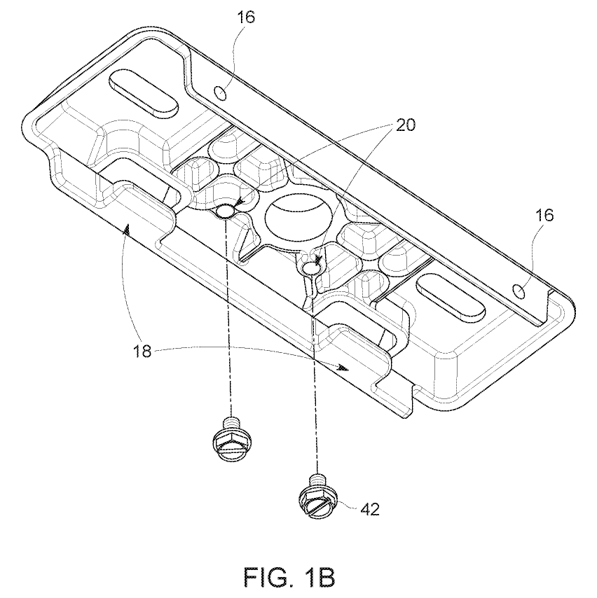

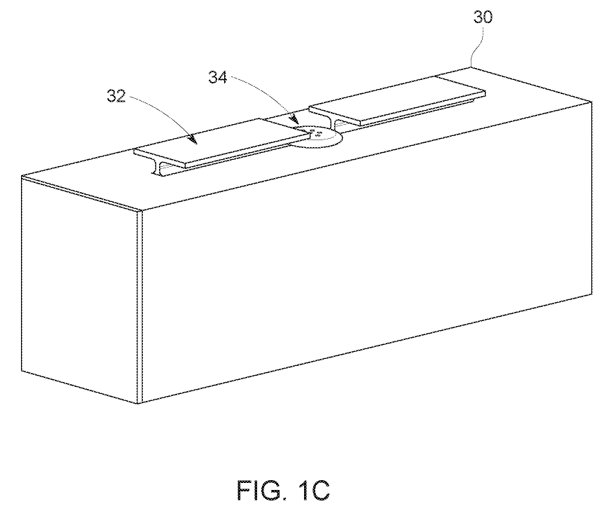

FIGS. 1A to 1C illustrate a light system 2 for a linear LED luminaire according to certain embodiments of present disclosure which includes a mounting bracket 10 and a housing 30 for housing a linear LED luminaire. A plurality of light systems 2 can be easily deployed to extend to any length to assemble and dissemble as explained hereinafter.

FIG. 1A is an exploded view of the mounting bracket 10 including a pair of surface mount slots 12 provided on a top surface thereof, a pendant mount threaded hole 14 between the surface mount slots 12. The mounting bracket has two sides extending perpendicular to the mounting bracket 10, a mounting panel side 16 and support legs side 18. The mounting panel side 16 further includes one or more openings 16-1 for a fastener, e.g. a screw, bolt, etc. to be inserted, provided at one end of the mounting bracket 10. The opposite side has the support legs side 18.

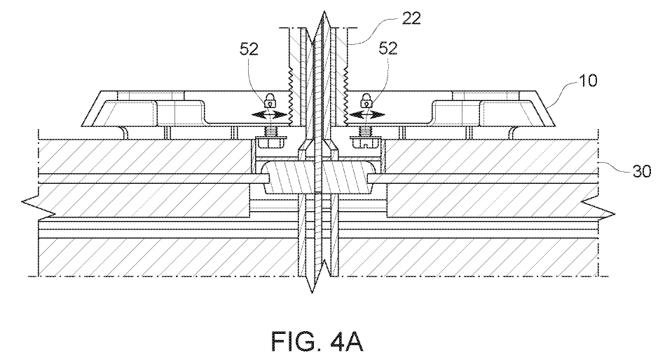

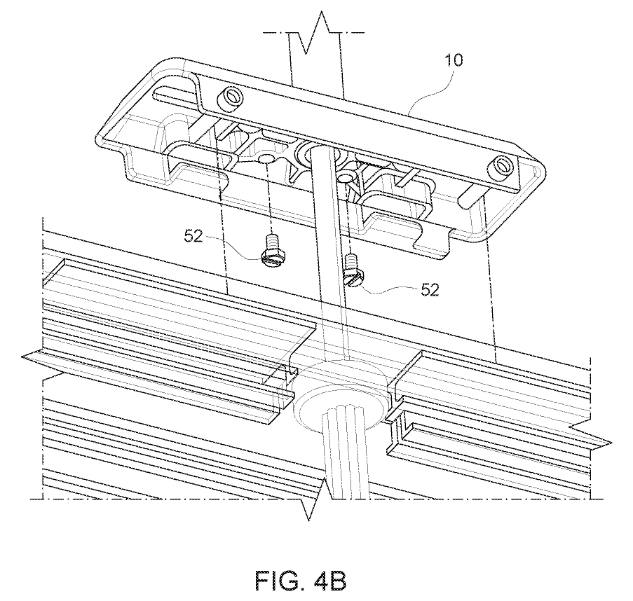

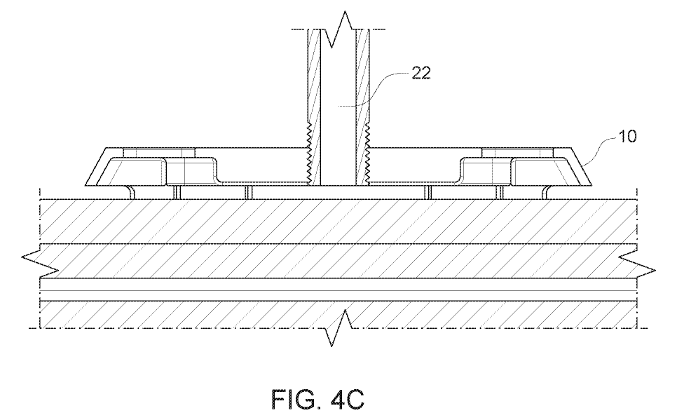

FIG. 1B is a bottom view of the mount bracket 10 shown in Fig. la which includes the pair of wide support legs 18 provided at a lower bottom of that side. The support legs side18 further includes a support ledge 18-1 that extends at a lower bottom of the side perpendicular to the mounting panel 16. A pair of stopper screws openings 20 receive a pair of stopper screws 42. The stopper screws 42 are affixed to the location 20 to prevent movement on the bracket 10 when a power feed is present within the mounting bracket 10 to avoid damaging the wires. Note that when the power feed is not present within the mounting bracket 10, the stopper screws 42 are not deployed to allow a lateral movement of the housing 30 during thermal expansion. Thus, the stopper screws 20 are only needed for each mounting bracket that has power feeds/wires to limit the relative movement, and must be pre- installed before mounting the light system 2 as explained later with reference to FIG. 4. The mount bracket 10 can be a die-cast aluminum bracket, for example, but it should be noted that other materials suitable to operate as bracket in the light application would be applicable.

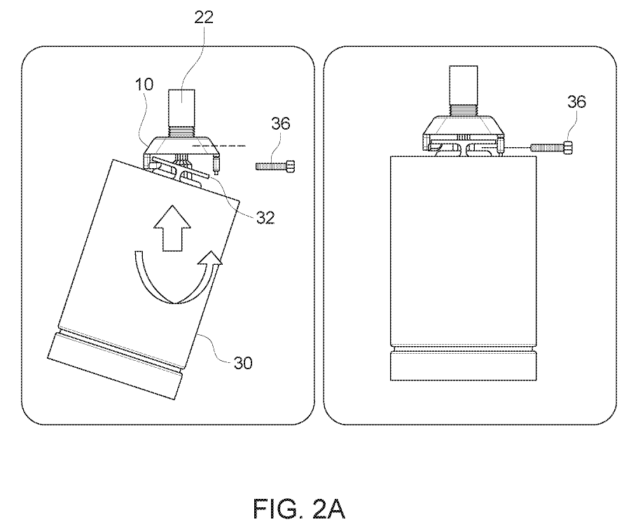

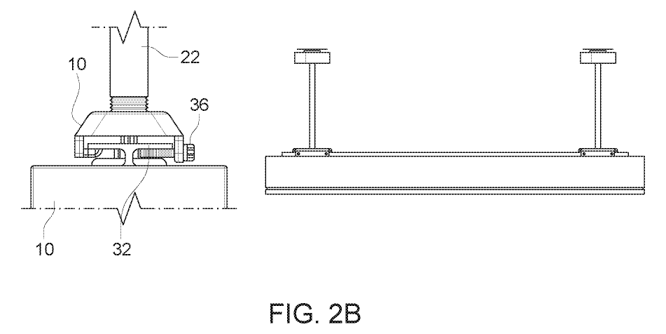

FIG. 1C is a housing 30 including at least one T-rail 32 on a top surface thereof and a wire gasket 34 provided between the T-rails 32. The wire gasket 34 serves to receive individual power leads/wires into the housing 30. The T-rail 32 are slidably mounted on the bottom of the mount bracket 10, thus allowing relative lateral movements between the mount bracket 10 and the housing 30 during thermal expansion and contraction, as explained with the reference to FIGS. 2and3.

Certain embodiments of the disclosure may provide for the light system 2 for a pendant application and a ceiling (or surface) application. On the pendant application, the pendant mount threaded hole 14 is tapped to allow a direct installation of the pendant stem. The power delivery is hidden within the stem through the pendant mount threaded hole 14 so that it can protect the wire from being damaged externally while keeping the water ingress protection of the fixture. On the ceiling or surface application, the mounting bracket 10 is mounted by bolts through the surface mount slots 12, which also provide room for potential misalignment during installation.

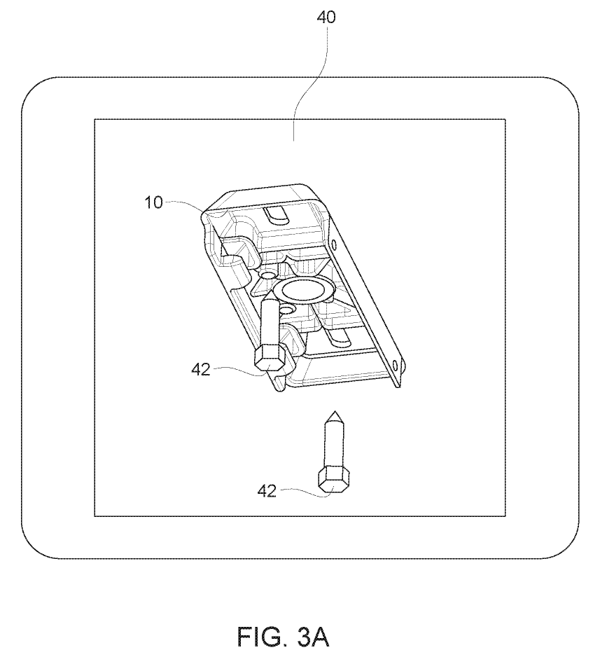

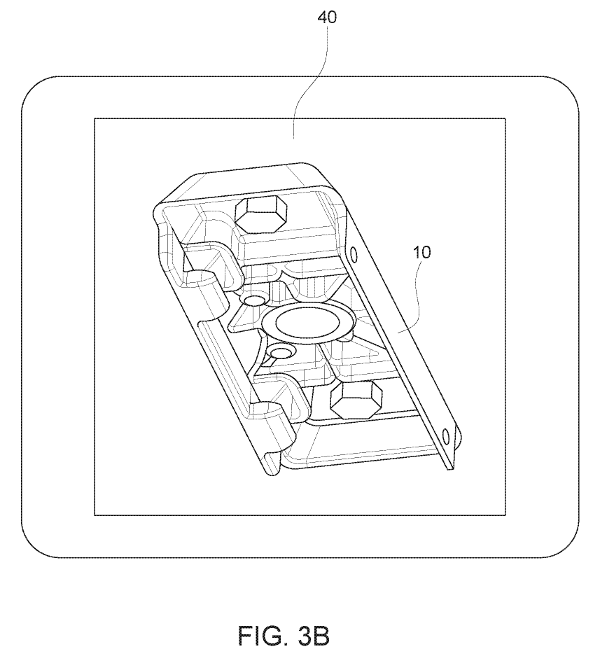

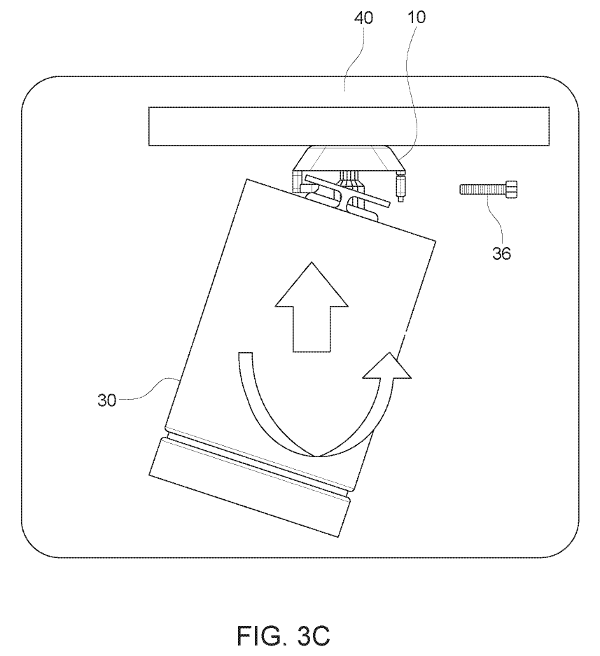

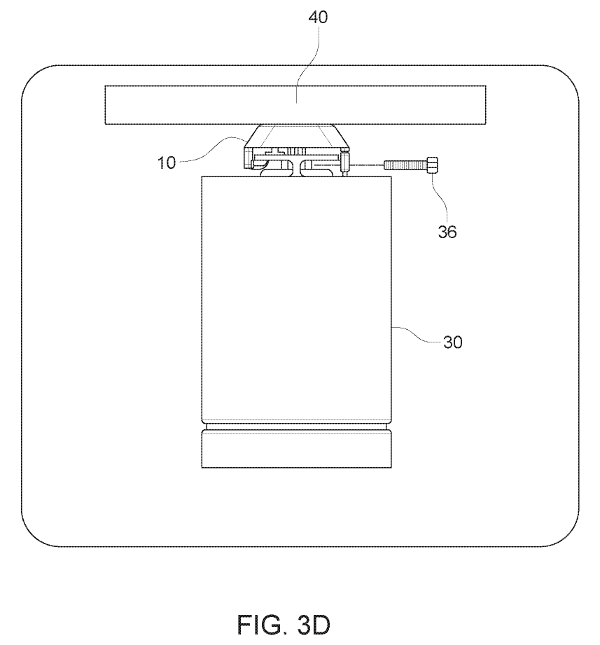

FIGS. 2 and 3 illustrate a detailed process of installing the housing 30 onto the mount bracket 10 for pendant application and wall/surface application, respectively.

As shown in FIG. 2A, the mount bracket 10 can be fasten to a pendant stem 22 that is suspended from a ceiling. Once the mount bracket 10 is affixed to the pendent stem 22, an installer tilts the housing 30 about 20 degrees to allow the T-rail 32 to engage with the legs 18 of the bracket 10, and then the housing 30 is tilted back at a substantially horizontal orientation or level while mounting screws 36 are fastened to secure the mounting. FIG. 2B illustrates a mounting schematic with secured connection as described above.

As shown in FIG. 3, the mount bracket 10 is mounted on the ceiling with two bolts 42, and the same operations with reference to FIG. 2 to fasten the housing 30 onto the mount bracket 10 is performed for surface application. It should be apparent to those skilled in the art that the installation operations shown in FIGS. 2 and 3 provides ease of installation for an installer as the side-entry bracket allows the fixture to be partially supported while finishing securing the connections at the other end. As a result, the installer will be able to focus on one step at a time before moving to the next which will reduce the error of installation and ultimately increase the speed and efficiency of the installation.

FIGS. 4A-4D illustrate an installation of stopper screws 52 according to certain embodiments. When the light system 2 is exposed to different ambient temperature, the fixture will expand or contract. When a number of linear light systems 2 are joined continuously, the expansion and contraction will propagate to every connected light systems 2, hence the light systems needs room to counter this movement. The bracket 10 and T-Rail 32 allows for this kind of movement. Important note is the stopper screws 52 is always used at a main power drop as shown in FIGS. 4A and 4B since any movement is not desired where wires are passing in between as explained earlier. When the light system 2 is assembled as explained in FIG. 2, the head of screws 52 protrudes out and blocked by the groove on T-rail 32 as shown in FIG. 4A, thus preventing any lateral movement. FIG. 4C shows other non- stopper instances where no stopper is installed due to absence of the main power drop with the light system 2. As such, when a number of light systems 2 is continuously extended from the light system with the main power drop, other light systems without having the main power drop would be configured as shown in FIG. 4C.

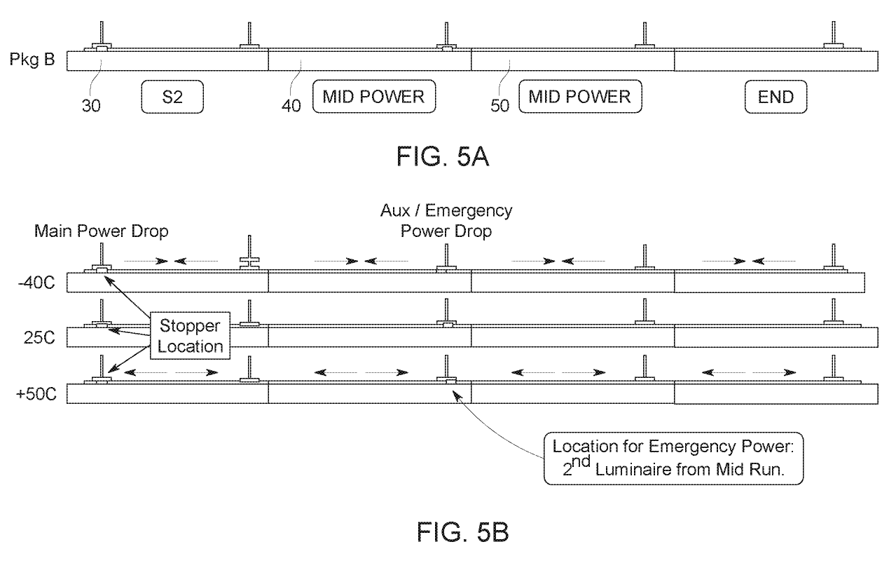

FIGS. 5A and 5B illustrates back-to-back connections of light systems 2 in linear format, for example.

As shown in FIG. 5A, a plurality of light systems 2 is extended continuously in which the left most light system 2 is provided with a main power drop and an emergency power drop is provided close to the main power drop to make the impact minimum. The main power drop bracket and the emergency power bracket will have the stopper screws 52 affixed thereto to limit the thermal movement. FIG. 5B shows arrows illustrating the thermal movement based on varying temperature and where the bracket movement will be stopped mechanically by the stopper screws 52 deployed in the main power drop and an emergency power drop brackets. Other brackets without having stopper screws 52 affixed thereto would allow the housing 30 to move counter to the lateral thermal expansion movement as shown by the arrows. It should be noted that only four housings are shown in describing the teachings of present disclosure in FIGS. 5 for illustrative purposes, thus the number of light systems shown in the drawing should not impose any restriction. One skilled in the art can readily appreciate any number light systems that are extended continuously can be implemented.

Embodiments disclosed herein advantageously provide mechanisms for easily and quickly install one or more elongated LED luminaires both electrically and mechanically while also providing alignment of the respective LED luminaires. Although the above embodiments were described for a linear arrangement of LED luminaires with no intervening breaks, it should be noted that the teachings of the above embodiments can be applicable to other conventional light fixtures may be utilized to anchor and/or position newly installed retrofit LED luminaires. The above descriptions and/or the accompanying drawings are not meant to imply a fixed order or sequence of steps for any process or method referred to herein. Thus, any disclosed process may be performed in any order that is practicable, including but not limited to simultaneous performance of one or more steps that are indicated as sequential.

While the embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

1. A system for installing a linear LED luminaire, comprising:
a bracket comprising top surface and two sides, one side is a support leg having a support ledge extending parallel to the top surface, and the other side is a mounting panel, including at least one opening parallel the at least one support ledge to receive at least one fastener; and
a housing including at least one T-rail on a top surface thereof, and an opening to receive wires,
wherein the at least one T-rail of the housing is configured to slidably engage with the at least one support leg, wherein a portion of the at least one T-rail is supported by the support ledge at a predetermined angle and tilted at a substantially horizontal orientation while the at least one fastener is inserted through the at least one opening of the mounting panel, wherein the fastener supports another portion of the at least one T-rail, to secure mounting of the housing onto the bracket.

2. The system of claim 1, wherein the bracket further comprising a pair of openings at a bottom surface thereof to receive a pair of stopper screws such that the heads of pair of screws are configured to block a sliding movement of the at least one T-rail when the housing is mounted onto the bracket.

3. The system of claim 2, wherein the pair of stopper screws is pre-installed in the bracket.

4. The system of claim 1, wherein the bracket further comprising a pair of mount slots on a planar surface thereof for affixing the bracket to a surface or a ceiling.

5. The system of claim 1, wherein the bracket further comprising an opening between the pair of mount slots for fastening to a pendant stem.
